(19) United States
(12) Patent Application Publication
(10) Pub. No.: US 2011/0153848 A1
(43) Pub. Date: Jun. 23, 2011

(54) INFORMATION PROCESSING DEVICE, COMMUNICATION SYSTEM, CONTROL METHOD AND CONTROL PROGRAM

(75) Inventors: Hironori SAKAKIHARA, Kawasaki (JP); Toru Kamiwada, Kawasaki (JP)

(73) Assignee: FUJITSU LIMITED, Kawasaki-shi (JP)

(21) Appl. No.: 12/973,894

(22) Filed: Dec. 20, 2010

(30) Foreign Application Priority Data
Dec. 21, 2009 (JP) 2009-289593

(51) Int. Cl. G06F 15/16

(52) U.S. Cl. 709/228

(57) ABSTRACT

An information processing device includes: a control data request signal reception unit configured to receive a request signal for requesting transmission of control data; a control data transmission unit configured to transmit control data required by the received request signal to a communication device; a control data transmission destination recording unit configured to record device identification information used for identification of a communication device in a manner correlated with identification information for identifying this provided data; a device selecting unit configured to select device identification information recorded in the control data transmission destination recording unit in a manner correlated with identification information for identifying the provided data; and a device identification information transmission unit configured to transmit the selected device identification information to a communication device on a P2P network as device identification information used for identification of a communication device in which the provided data is recorded.

### CROSS-REFERENCE TO RELATED APPLICATIONS

This application is based upon and claims the benefit of priority of the prior Japanese Patent Application No. 2009-289593, filed on Dec. 21, 2009, the entire contents of which are incorporated herein by reference.

### FIELD

The present invention relates to an information processing device used for a system for multiple communication devices connected to a communication network obtaining and using provided data by transmission/reception between communication devices.

### BACKGROUND

There has been much attention focused on a communication system called P2P (Peer-to-Peer) for performing transfer of various types of information by mutually relaying various types of information between node (client) devices, unlike with a client-server type. With P2P, in order to perform retrieval and transfer of a recording destination of information between node devices, load is not concentrated on a particular server device even when each node device attempts to obtain a target content around the same time, as with a client-server type.

With Japanese Unexamined Patent Application Publication No. 2006-197400, a communication system according to P2P is discussed. With P2P, each node device connected to a communication network serves as a node such as a contents recording node, a contents location managing node, contents retrieval node, or the like. The contents recording nodes are nodes in which contents data such as video data, music data, or the like, is recorded for distributing the recorded contents data. The contents location managing nodes are nodes for providing information indicating a node device which serves as a contents recording node. The contents retrieval nodes are nodes for inquiring of a contents location managing node for a node in which contents data is recorded.

A node device serving as a contents recording node repeats processing for transmitting record notification information indicating that contents data is recorded to another node device connected to the communication network. The node device which has received the record notification information serves as a contents location managing node for providing information indicating the contents recording node.

In the event that a node device connected to the communication network desires to obtain contents data, this node device serves as a contents retrieval node. The contents retrieval node inquires of the contents location managing node for information indicating the contents recording node in which desired contents data is recorded. Subsequently, the contents retrieval node which has performed inquiry obtains reply regarding the content recording node in which the desired contents data is recorded. The contents retrieval node obtains the desired contents data by requesting transmission of contents data from the contents recording node based on the obtained reply. Also, the node device which has obtained contents data records contents data, and serves as a contents recording node.

### SUMMARY

According to an aspect of the invention, an information processing device includes: a control data request signal reception unit configured to receive a request signal for requesting transmission of control data used for processing for controlling whether or not provided data to be provided to a communication device is available in the communication device; a control data transmission unit configured to transmit control data required by the received request signal to a communication device which is a requestor that sends the request signal; a control data transmission destination recording unit configured to record device identification information used for identification of a communication device which is a transmission destination of the control data in a manner correlated with identification information for identifying this provided data; a device selecting unit configured to select device identification information recorded in the control data transmission destination recording unit in a manner correlated with identification information for identifying the provided data; and a device identification information transmission unit configured to transmit the selected device identification information to a communication device on a P2P network as device identification information used for identification of a communication device in which the provided data is recorded.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one embodiment.

FIG. 2 is a block diagram illustrating hardware according to one embodiment.

FIG. 3 is a functional block diagram illustrating the functions of an information processing device according to one embodiment.

FIG. 4A is an explanatory diagram illustrating a control data recording unit of the information processing device according to one embodiment.

FIG. 4B is an explanatory diagram illustrating the control data recording unit of the information processing device according to one embodiment.

FIG. 5 is an explanatory diagram illustrating a device identification information recording unit of the information processing device according to one embodiment.

FIG. 6 is an explanatory diagram illustrating a control data transmission destination recording unit of the information processing device according to one embodiment.

FIG. 7 is a functional block diagram illustrating the functions of a communication device according to one embodiment.

FIG. 8 is a functional block diagram illustrating the functions of the communication device according to one embodiment.

FIG. 9 is a functional block diagram illustrating the functions of the communication device according to one embodiment.

FIG. 10 is a flowchart illustrating provided data obtaining processing between the communication devices according to one embodiment.

FIG. 11 is a flowchart illustrating provided data use processing of the communication device according to one embodiment.

FIG. 12 is a flowchart illustrating control data transmission processing of the information processing device according to one embodiment.

FIG. 13 is a flowchart illustrating provided data identification information selecting processing of the information processing devices according to one embodiment.

FIG. 14 is a flowchart illustrating device identification information notification processing of the information processing device according to one embodiment.

FIG. 15 is an explanatory diagram illustrating a telegram message to be transmitted by the information processing device according to one embodiment.

FIG. 16 is a flowchart illustrating device identification information record processing of the communication device according to one embodiment.

FIG. 17 is a flowchart illustrating the device identification information notification processing of the information processing device according to one embodiment.

FIG. 18 is a functional block diagram illustrating the functions of the information processing device according to one embodiment.

FIG. 19 is an explanatory diagram illustrating a classification-by-class recording unit of the information processing device according to one embodiment.

FIG. 20 is an explanatory diagram illustrating relationship between classes and a transmission route with a communication system according to one embodiment.

FIG. 21 is an explanatory diagram illustrating the transmission route of device identification information with the communication system according to one embodiment.

FIG. 22 is a flowchart illustrating the device identification information notification processing of the information processing device according to one embodiment.

FIG. 23 is a block diagram illustrating the communication device according to one embodiment.

FIG. 24 is a flowchart illustrating the operation of the communication device according to one embodiment.

### DESCRIPTION OF EMBODIMENTS

The communication system according to P2P has a problem in that load is increased by recording contents data. For example, each node device serving as a contents recording node repeatedly transmits record notification information, so processing load increases. Also, with a communication network serving as a transmission medium of the record notification information, communication load increases.

With one embodiment, in the event that control data is necessary at the time of controlling whether or not contents data or provided data is available, processing load and communication load based on record notification information is reduced. An information processing device in which the control data is recorded manages a node device (communication device) which has requested the control data by regarding this node device as a contents recording node. In this way, the processing load of a communication device, and the communication load of a communication network are reduced.

The information processing device according to one embodiment includes a control data request signal reception unit, a control data transmission unit, a control data transmission destination recording unit, a device selecting unit, and a device identification information transmission unit. The control data request signal reception unit receives a request signal for requesting transmission of control data to be used for processing for controlling whether or not provided data to be provided to a communication device is available at the communication device. The control data transmission unit transmits control data requested by the received request signal to a communication device which is a requestor. The control data transmission destination recording unit records device identification information to be used for identification of a communication device which is a transmission destination of the control data in a manner correlated with the provided data. The device selecting unit selects the entire or part of the device identification information recorded in the control data transmission destination recording unit in a manner correlated with the entire or part of the provided data. The device identification information transmission unit transmits the selected device identification information to a device on the P2P network as device identification information to be used for identification of the communication device in which the provided data is recorded.

With one embodiment, the information processing device manages a communication device which has requested control data by regarding this communication device as a contents recording node. Thus, various excellent advantages are provided such that broadcast transmission of record notification information transmitted by each communication device is reduced, and the processing load of communication devices, and the communication load of a communication network are reduced, and so forth.

Now, description will be made in detail based on drawings indicating embodiments.

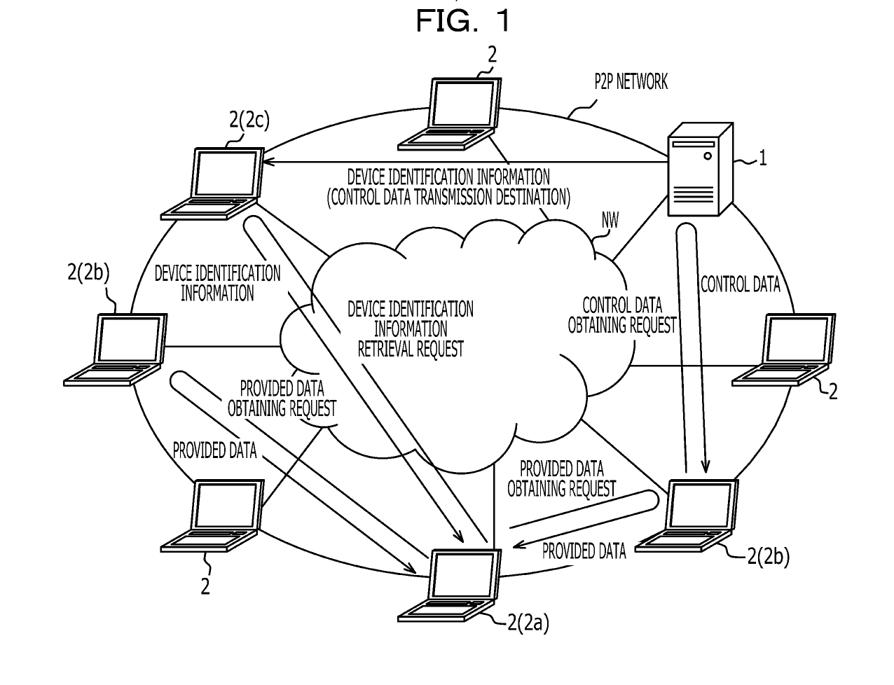

FIG. 1 is a conceptual diagram illustrating a communication system according to one embodiment. With the communication system, multiple devices such as an information processing device 1, communication devices 2, and so forth are connected to a communication network NW such as the Internet or the like, and each device mutually communicates via the communication network NW.

The communication system serves as a communication system called P2P (Peer-to-Peer). This communication system is called a P2P network. With the P2P network, each of the communication devices 2 serves as a node assuming various roles.

For example, the communication device 2 in which provided data is recorded serves as a contents recording node. Also, another communication device 2 in which the information of the communication device 2 in which provided data is recorded (information that correlates the provided data with the communication device 2) is recorded serves as a contents location managing node. Further, the communication device 2 serves as a contents retrieval node for accessing the communication device 2 which is a contents location managing node to retrieve the communication device 2 which is a contents recording node. With the drawings and the subsequent description, the communication device 2 serving as a contents retrieval node is illustrated as a communication device 2a, the communication device 2 serving as a contents recording node is illustrated as a communication device 2b, and the communication device 2 serving as a contents location managing node is illustrated as a communication device 2c.

The communication device 2a serving as a contents retrieval node requests provided data from a single or multiple communication devices 2b obtained by retrieving the communication devices 2c. The communication device 2b, from which the provided data has been requested, transmits the provided data to the communication device 2a which is a requestor. Subsequently, the communication device 2a which has received the provided data becomes the communication device 2b serving as a contents recording node by recording the provided data. Note that, in order to use the provided data, the control data to be provided from the information processing device 1 is required.

The information processing device 1 is a device such as a server computer in which control data for providing licensing of the provided data to be provided to the communication devices 2 is recorded, or the like. The information processing device 1 is managed, for example, by a manager of a business organizer or the like serving as a distributor of the provided data.

The provided data is, for example, contents data, and is playback data having a format such as MPEG (Moving Picture Experts Group) for playing video, MP3 (MPEG Audio Layer-3) for playing audio, or the like. However, the provided data is not restricted to such playback data, and exhibits various types of data to be provided to the communication device 2, such as still images, game contents, and so forth.

The control data is data to be used for processing for controlling whether or not the provided data is available at the communication device 2. Note that, with the following embodiments, the control data is licensing data for providing licensing of the provided data, and for example, in the event that the provided data is encrypted, description will be made assuming that key data for decrypting the encrypted data is used as the control data. Note that the control data may be used as data for making the provided data unusable.

The communication device 2 serves as various types of node as described above, and is a device such as a personal computer for using licensed provided data, e.g., performing playback of video, or the like. The communication device 2 is operated, for example, by a user who uses the provided data.

The provided data is licensed by being decoded using the control data. The use of the provided data by the communication device 2 indicates that processing such as playback of video, playback of audio, display of a still image, execution of a game content, or the like is performed.

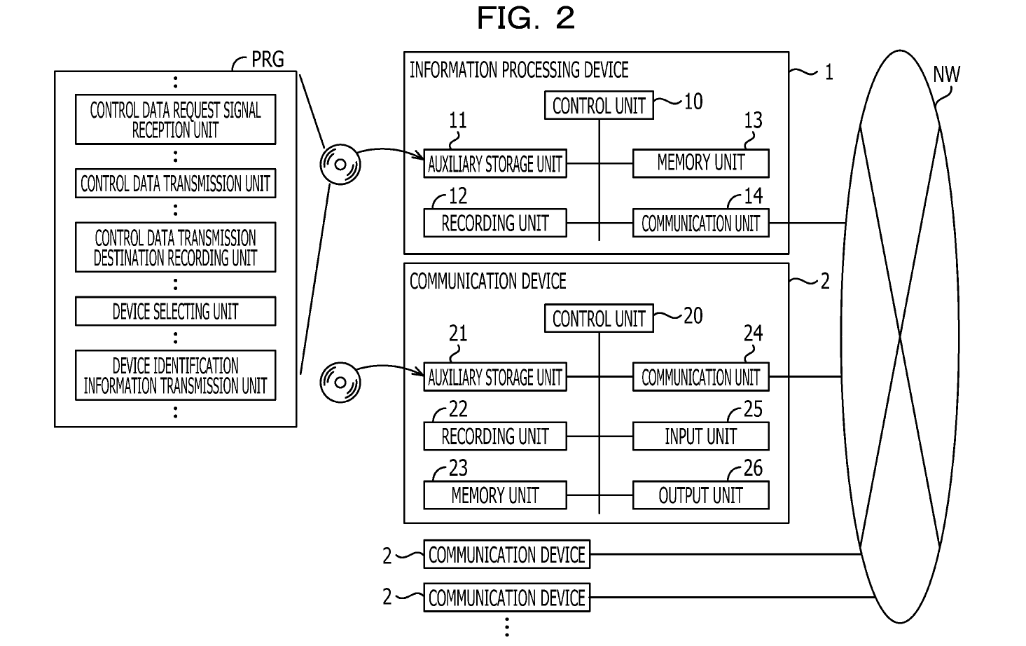

Next, the hardware of the device to be used will be described. FIG. 2 is a block diagram illustrating the hardware of the device to be used with the communication system. The information processing device 1 includes hardware such as a control unit 10, an auxiliary storage unit 11, a recording unit 12, a memory unit 13, a communication unit 14, and so forth.

The control unit 10 is a computing mechanism such as a CPU (Central Processing Unit) for controlling the entire device. The control unit 10 is connected to each hardware unit of the information processing device 1 via internal communication lines, and executes processing of various types of program such as control program PRG and so forth. The control unit 10 includes various types of circuits such as an instruction register, an instruction decoder, an arithmetic logic unit, an accumulator, an address register, a program counter, and so forth. The instruction register temporarily stores the instruction read from the memory unit 13. The instruction decoder decodes a machine language instruction (binary) stored in the instruction register, and controls each hardware unit included in the information processing device 1 according to the instruction thereof. The arithmetic logic unit performs calculation such as addition, subtraction, comparison between numeric values, or the like in accordance with the control from the instruction decoder. The accumulator temporarily stores information such as data to be calculated, calculation results, and so forth. The address register stores the address of a memory area included in the memory unit 13 where the control unit 10 reads or writes. The program counter indicates the address of a memory area included in the memory unit 13 where an instruction to be executed next is stored. Also, the control unit 10 includes a timer used for timekeeping.

The auxiliary storage unit 11 is a reading mechanism such as an optical drive for reading various types of information such as a control program PRG and data from a recording medium such as CD-ROM, DVD-ROM, or the like.

The recording unit 12 is a magnetic recording mechanism such as an HDD (Hard Disk Drive) or the like, a recording mechanism such as a nonvolatile semiconductor recording mechanism such as an SSD (Solid State Disk) or the like. Various types of information such as the control program PRG and data read by the auxiliary storage unit 11, and so forth is recorded in the recording unit 12. Note that not only the control program PRG but also various computer programs for executing various types of processing, and data are recorded in the recording unit 12.

The memory unit 13 is a storage mechanism such as a volatile storage mechanism such as RAM (Random Access Memory).

The information processing device 1 reads various types of information such as the control program PRG recorded in the recording unit 12, temporarily stores this in the memory unit 13, and executes this by the control of the control unit 10, whereby various types of processing serving as the information processing device 1 are executed.

The communication unit 14 is a communication mechanism made up of hardware such as various types of circuits, and software such as firmware, which connect to the communication network NW to execute communication processing with the communication devices 2 via the communication network NW.

The communication devices 2 include various types of mechanisms such as a control unit 20, an auxiliary storage unit 21, a recording unit 22, a memory unit 23, a communication unit 24, an input unit 25, an output unit 26, and so forth.

The communication devices 2 read information such as the program and data for communication devices from a recording medium by the auxiliary storage unit 21 to store this in the recording unit 22. Note that an arrangement may be made wherein the communication device 2 is connected to the communication network NW by the communication unit 24, and downloads various types of information from another device such as the information processing device 1 or the like via the communication network NW instead of being read from a recording medium.

Subsequently, the communication devices 2 read various types of information recorded in the recording unit 22, temporarily store these in the memory unit 23, and execute this by the control of the control unit 20, whereby various types of processing serving as the communication device 2 are executed.

The input unit 25 is an interface mechanism for accepting an input person's operations. The input unit 25 outputs a signal corresponding to the input person's operation to the control unit 20 via internal communication lines. The input unit 25 uses various mechanisms, for example, such as a keyboard, a mouse, an attached circuit thereof, an attached program thereof, and so forth.

The output unit 26 is an interface mechanism for outputting an image and audio. The output unit 26 uses various mechanisms, such as a liquid crystal display for outputting an image based on the control instruction from the control unit 20, a speaker for outputting audio, an attached circuit thereof, an attached program thereof, and so forth.

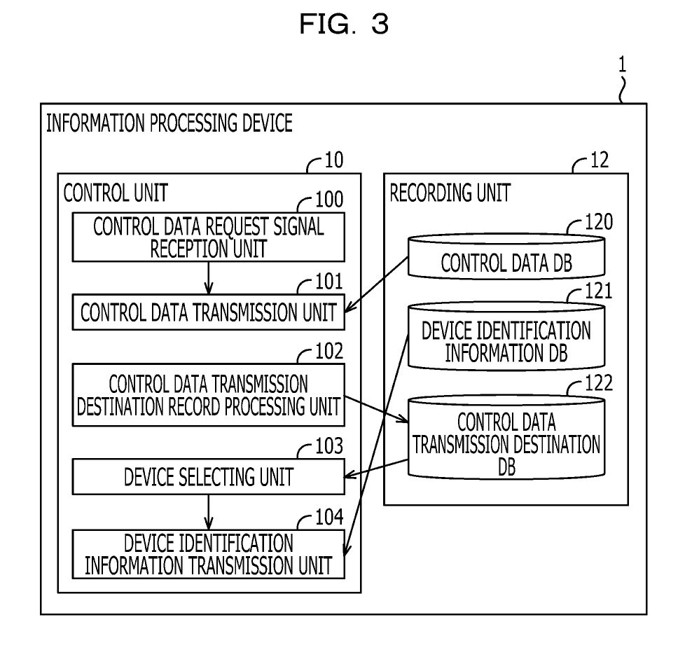

Next, the functions of devices to be used will be described. FIG. 3 is a functional block diagram illustrating the functions of the information processing device 1. The information processing device 1 reads out the control program PRG from the memory unit 13 to execute this at the control unit 10. The control unit 10 executes the control program PRG, thereby realizing the functions of the control data request signal reception unit 100, control data transmission unit 101, control data transmission destination record processing unit 102, device selecting unit 103, device identification information transmission unit 104, and so forth. Note that a circuit for realizing the functions of the control data transmission unit 101, control data transmission destination record processing unit 102, device selecting unit 103, device identification information transmission unit 104, and so forth may be embedded in the control unit 10 instead of execution of the control program PRG.

The control data request signal reception unit 100 is an element such as a program module, circuit, or the like for causing the control unit 10 to operate so as to receive a control data transmission request signal for requesting transmission of the recorded control data.

The control data transmission unit 101 is an element such as a program module, circuit, or the like for causing the control unit 10 to operate so as to transmit the requested control data to the communication device 2 which is a requestor in response to the request for transmission of the control data by a control data transmission request signal.

The control data transmission destination record processing unit 102 is an element such as a program module, circuit, or the like for causing the control unit 10 to operate so as to record device identification information for identifying the communication device 2 which is a transmission destination of the control data in the recording unit 12 as the device identification information of the communication device 2 in which the provided data is recorded.

The device selecting unit 103 is an element such as a program module, circuit, or the like for causing the control unit 10 to operate so as to select the entire or part of the device identification information recorded in a manner correlated with the entire or part of the provided data in the recording unit 2. The device identification information to be selected is device identification information for identifying the communication device 2 which serves as a contents recording node. The device identification information that the device selecting unit 103 selects is device identification information to be notified in response to a request for a contents recording node, and the selected device identification information is transmitted to the communication device 2c serving as a contents location managing node.

The device identification information transmission unit 104 is an element such as a program module, circuit, or the like for causing the control unit 10 to operate so as to transmit the device identification information of the communication device 2 which the device selecting unit 103 selected as device identification information to be used for identification of the communication device 2 in which the provided data is recorded. The transmission destination of the device identification information is the communication device 2c serving as a contents location managing node.

Also, the information processing device 1 uses a portion of the record region of the recoding unit 12 as various types of databases by executing the control program PRG based on the control of the control unit 10. Examples of the various types of databases include a control data recording unit (control data DB) 120, a device identification information recording unit (device identification information DB) 121, and a control data transmission destination recording unit (recording device DB) 122. Note that another recording device connected to the information processing device 1 may be used as various types of databases instead of using a portion of the record region of the recording unit 12 as various types of databases.

The control data recording unit 120 is a database in which the control data to be used for controlling whether or not the provided data provided to the communication device 2 is available is recorded.

The device identification information recording unit 121 is a database in which device identification information for identifying the communication device 2 is recorded.

The control data transmission destination recording unit 122 is a database in which device identification information for identifying the communication device 2 which is a transmission destination to which the control data was transmitted is recorded.

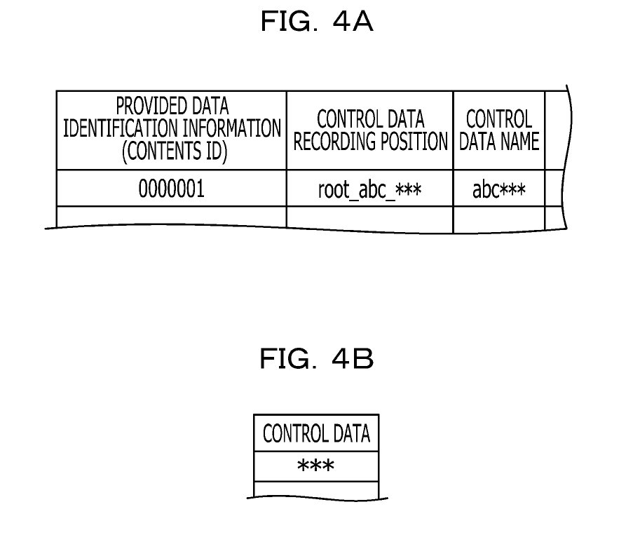

FIGS. 4A and 4B are explanatory diagrams conceptually illustrating an example of the record content of the control data recording unit 120 of the information processing device 1. FIG. 4A illustrates record content to be used as the index of the control data recorded in the control data recording unit 120. As illustrated in FIG. 4A, various types of information such as provided data identification information (content ID) for identifying the provided data, the record position of the control data, the name (file name) of the control data, and so forth are recorded in the control data recording unit 120 in increments of records. FIG. 4B illustrates the recorded control data. The information processing device 1 determines the record position and name of the control data with provided data identification information for identifying the provided data as a key, and extracts the control data corresponding to the provided data based on the determined record position and name.

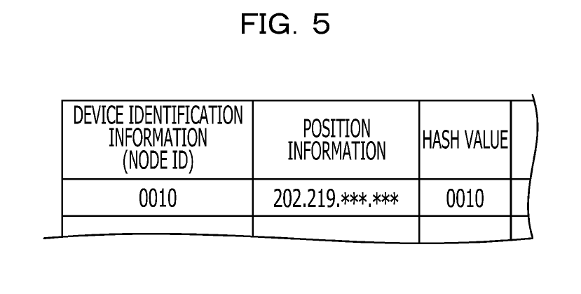

FIG. 5 is an explanatory diagram conceptually illustrating an example of the record content of the device identification information recording unit 121 of the information processing device 1. Various types of information such as device identification information (node ID), position information, hash value, and so forth are recorded in the device identification information recording unit 121 in a manner correlated with each other in increments of records. The position information is information such as an IP address, port number, or the like which indicates a position on the communication network NW. The hash value is N-digit (N is a natural number) binary obtained by subjecting the device identification information to irreversible transformation using a hash function.

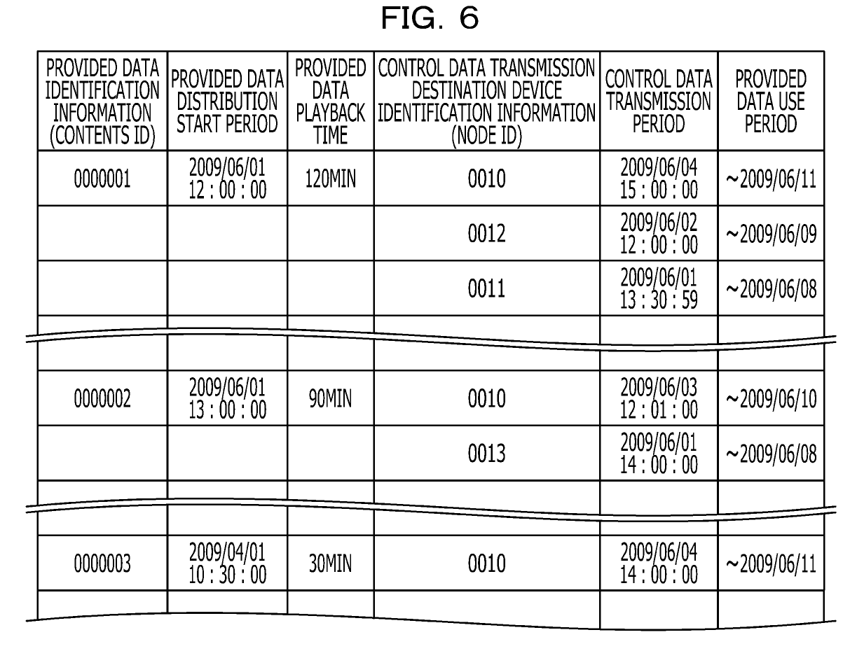

FIG. 6 is an explanatory diagram conceptually illustrating an example of the record content of the control data transmission destination recording unit 122 of the information processing device 1. Various types of information relating to the provided data such as provided data identification information, provided data distribution start period, provided data playback time, and so forth are recorded in the control data transmission destination recording unit 122 as a record correlated with each other. Further, in a manner correlated with information regarding these provided data, various types of information such as device identification information, control data transmission period, a provided data use period, and so forth are recorded as a record correlated with each other. The provided data distribution start period indicates date and time when distribution of the provided data was started. The provided data playback time indicates, in the event that the provided data is playback data such as audio data, video data, or the like, time for playback. The device identification information is the device identification information of the communication device 2b serving as a contents recording node. The control data transmission period indicates date and time when the control data was transmitted. The provided data use period indicates a period wherein the provided data of which the use is permitted by the control data may be used. With the example illustrated in FIG. 6, the provided data of which the provided data identification information is 0000001 is playback data with the distribution being started from 12:00 on Jun. 1, 2009, and with playback time being 120 minutes. The control data that validates this provided data is transmitted to the communication devices 2, 2, and 2 of which the device identification information is “0010”, “0012”, and “0011”. Also, the use period of this provided data is one week since transmission of the control data. Note that not only the transmission period of the control data but also a reception period when a control data transmission request signal for requesting transmission of the control data was received may be recorded.

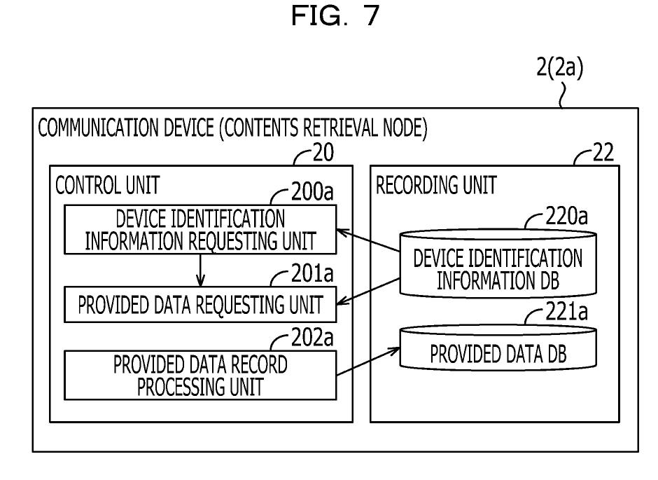

FIG. 7 is a functional block diagram illustrating the functions of the communication device 2. The communication device 2 illustrated in FIG. 7 indicates the communication device 2a serving as a contents retrieval node. The communication device 2a executes the functions of a device identification information requesting unit 200a, a provided data requesting unit 201a, a provided data record processing unit 202a, and so forth by the control of the control unit 20.

The device identification information requesting unit 200a is an element such as a program module or the like for causing the control unit 20 to operate so as to request that device identification information for identifying the communication device 2b which is a contents recording node is retrieved and transmitted, from the communication device 2c which is a contents location managing node.

The provided data requesting unit 201a is an element such as a program module or the like for causing the control unit 20 to operate so as to request the provided data from the communication device 2b which is a contents recording node based on the device identification information obtained as a response as to the request of the device identification information requesting unit 200a.

The provided data record processing unit 202a is an element such as a program module or the like for causing the control unit 20 to operate so as to record the provided data transmitted as a response as to the request of the provided data requesting unit 201a in the recording unit 22.

Also, the communication device 2a uses a portion of the record region of the recording unit 22 as various types of databases such as a device identification information recording unit (device identification information DB) 220a, provided data recording unit (provided data DB) 221a, and so forth. The record content of the device identification information recording unit 220a is the same as the record content of the device identification information recording unit 121 included in the information processing device 1. The provided data recording unit 221a is a database in which the provided data is recorded in a manner correlated with the provided data identification information.

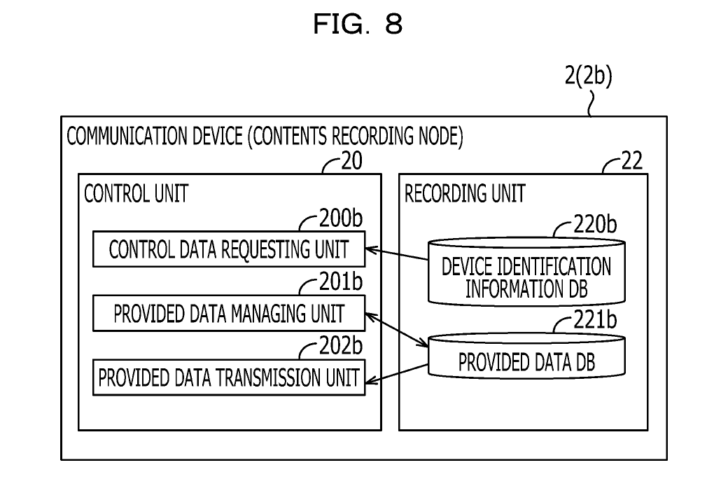

FIG. 8 is a functional block diagram illustrating the functions of the communication device 2. The communication device 2 illustrated in FIG. 8 indicates the communication device 2b serving as a contents recording node. The communication device 2b executes the functions of a control data requesting unit 200b, a provided data managing unit 201b, a provided data transmission unit 202b, and so forth by the control of the control unit 20.

The control data requesting unit 200b is an element such as a program module for causing the control unit 20 to operate so as to transmit a control data requesting signal for requesting transmission of the control data necessary for controlling whether or not the provided data recorded in the recording unit 22 is available from the information processing device 1.

The provided data managing unit 201b is an element such as a program module for causing the control unit 20 to operate so as to manage the provided data recorded in the recording unit 22. The management of the provided data is processing, for example, such as processing of decrypting or the like for permitting use of the provided data by the control data, processing for executing provided data such as playback of the provided data of which the use is permitted, or the like, processing for making the provided data of which the use period has elapsed unusable, and so forth. The processing for making unusable is processing such as elimination of decrypted provided data.

The provided data transmission unit 202b is an element such as a program module or the like for causing the control unit 20 to operate so as to transmit the provided data recorded in the recording unit 22 in response to a request of the provided data from another communication device 2.

Also, the communication device 2b uses a portion of the record region of the recording unit 22 as various types of databases such as a device identification information recording unit (device identification information DB) 220b, a provided data recording unit (provided data DB) 221b, and so forth. The record content of the device identification information recording unit 220b is the same as the record content of the device identification information recording unit 121 of the information processing device 1. The provided data recording unit 221b is a database in which the provided data is recorded in a manner correlated with the provided data identification information. Note that the provided data after licensing may also be recorded.

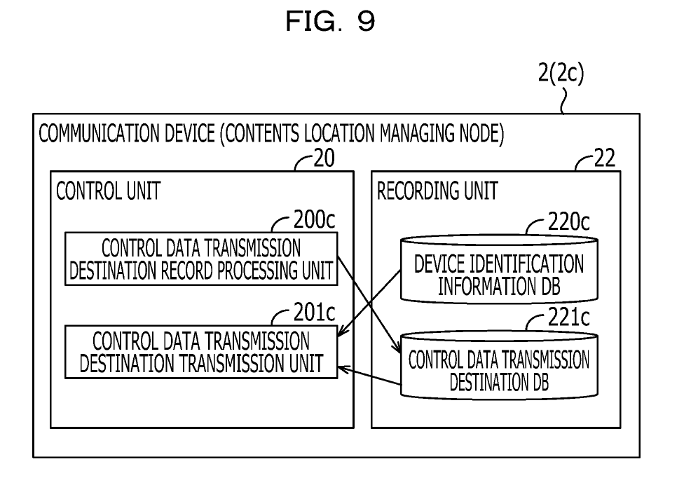

FIG. 9 is a functional block diagram illustrating the functions of the communication device 2. The communication device 2 illustrated in FIG. 9 indicates the communication device 2c serving as a contents location managing node. The communication device 2c executes the functions of a control data transmission destination record processing unit 200c, a control data transmission destination transmission unit 201c, and so forth by the control of the control unit 20.

The control data transmission destination record processing unit 200c is an element such as a program module or the like for causing the control unit 20 to operate so as to record the device identification information of the communication device 2b serving as a contents recording node received from the information processing device 1 in the recording unit 22.

The control data transmission destination transmission unit 201c is an element such as a program module or the like for causing the control unit 20 to operate so as to transmit the device identification information recorded in the recording unit 22 as a response in response to a request for device identification information from the communication device 2a serving as a contents retrieval node.

Also, the communication device 2c may use a portion of the record region of the recording unit 22 as various types of databases such as a device identification information recording unit (device identification information DB) 220c, a control data transmission destination recording unit (control data transmission destination DB) 221c, or the like. The record content of the device identification information recording unit 220c is the same as the record content of the device identification information recording unit 121 included in the information processing device 1. The control data transmission destination recording unit 221c is a database in which the device identification information of the communication device 2b serving as a contents recording node received from the information processing device 1 is recorded. The device identification information for identifying the transmission destination of the control data is recorded in the control data transmission destination recording unit 221c as device identification information correlated with the provided data identification information.

Note that, for convenience of description, the communication devices 2 serving as each of a contents location managing node, a contents recording node, and a contents retrieval node have been described, but the communication devices 2 also serve as any node.

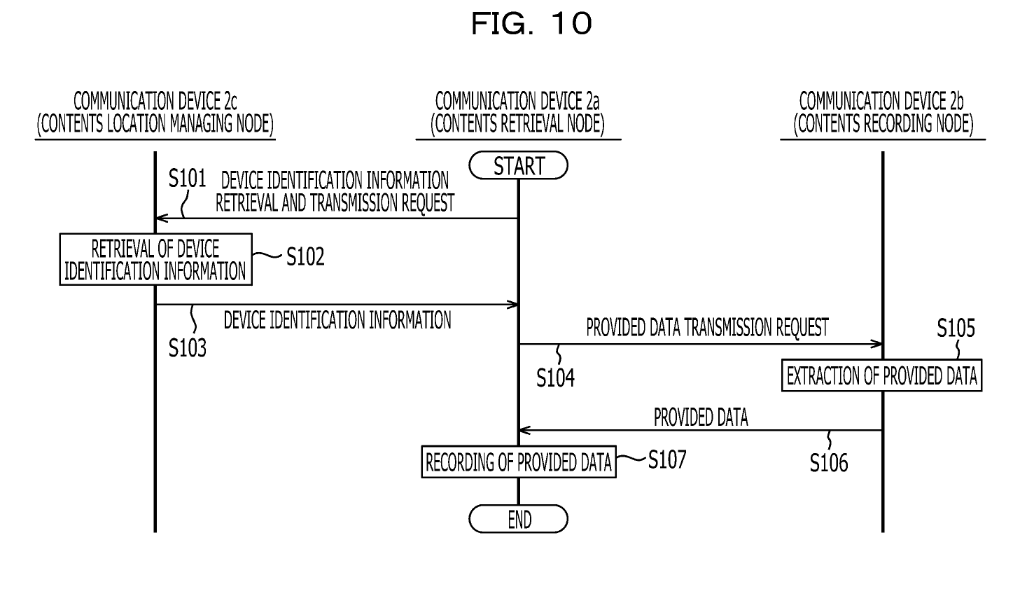

Next, the processing of various types of devices will be described. FIG. 10 is a flowchart illustrating an example of provided data obtaining processing between the communication devices 2 according to one embodiment as a sequence diagram. The provided data obtaining processing is processing until the communication device 2a serving as a contents retrieval node obtains the provided data.

The communication device 2a requests retrieval and transmission of the device identification information of the communication device 2b serving as a contents recording node from the communication device 2c serving as a contents location managing node by the processing of the device identification information requesting unit 200a based on the control of the control unit 20 (S101). The request for retrieval and transmission of the device identification information is transmitted as a telegram message from the communication unit 24 via the communication network NW. The provided data identification information for identifying the provided data to be requested is included in the telegram message to be transmitted. Note that the communication device 2a recognizes the communication device 2c based on communication such as inquiry of the other communication devices 2, transmission from the communication device 2c itself serving as a contents location managing node, or the information processing device 1, or the like.

The communication device 2c serving as a contents location managing node retrieves device identification information recorded as device identification information for identifying the transmission destination of the control data from the control data transmission destination recording unit 221c based on a request for retrieval and transmission of device identification information by the control of the control unit 20 (S102). In operation S102, based on the provided data identification information included in the telegram message received as the request for retrieval and transmission, the corresponding device identification information is retrieved out of the device identification information recorded in the control data transmission destination recording unit 221c as device identification information for identifying the transmission destination of the control data. In the event that there are a plurality of the corresponding device identification information, all of these are taken as retrieval results. Note that in the event that the number of the corresponding device identification information is great, the upper limit value may be provided.

Subsequently, the control unit 20 causes the control data transmission destination transmission unit 201c to transmit the device identification information retrieved from the control data transmission destination recording unit 221c to the communication device 2a which is a requestor from the communication unit 24 via the communication network NW (S103).

The communication device 2a serving as a contents retrieval node receives the device identification information at the communication unit 24 by the control of the control unit 20. Subsequently, the control unit 20 causes the provided data requesting unit 201a to request transmission of the provided data from the communication device 2b serving as a contents recording node to be identified by the device identification information (S104). The communication device 2a obtains the position information of the communication device 2b from the device identification information with reference to the device identification information recording unit 220a. The request for transmission of the provided data is transmitted as a telegram message from the communication unit 24 via the communication network NW based on the obtained position information. Provided data identification information for identifying the requested provided data is included in the telegram message to be transmitted. Also, in the event that a plurality of the device identification information have been received, transmission of the provided data is requested from the multiple communication devices 2b identified by all or part of the device identification information. A different portion of the provided data is requested from each of the communication devices 2b, thereby reducing the processing load of each of the communication devices 2b. Note that the upper limit value may be provided to the number of the communication devices 2b serving as requestors.

The communication device 2b serving as a contents recording node extracts the provided data from the provided data recording unit 221b by the control of the control unit 20 based on the request for transmission of the provided data (S105). In operation S105, the communication device 2b extracts the provided data based on the provided data identification information included in the telegram message received as the request for transmission of the provided data. Note that in the event that part of the provided data is specified, the specified part is divided from the extracted provided data.

Subsequently, the control unit 20 causes the provided data transmission unit 202b to transmit the provided data extracted from the provided data recording unit 221b to the communication device 2a serving as a requestor from the communication unit 24 via the communication network NW (S106).

The communication device 2a serving as a contents retrieval node receives the provided data at the communication unit 24 by the control of the control unit 20. Subsequently, the control unit 20 causes the provided data record processing unit 202a to record the provided data in the provided data recording unit 221a (S107). In the event that each part of the divided provided data is received from a plurality of the communication devices 2b the provided data is restructured and recorded by combining each portion. Subsequently, the communication device 2 serves as a contents recording node in the following processing.

In this way, the provided data obtaining processing is executed.

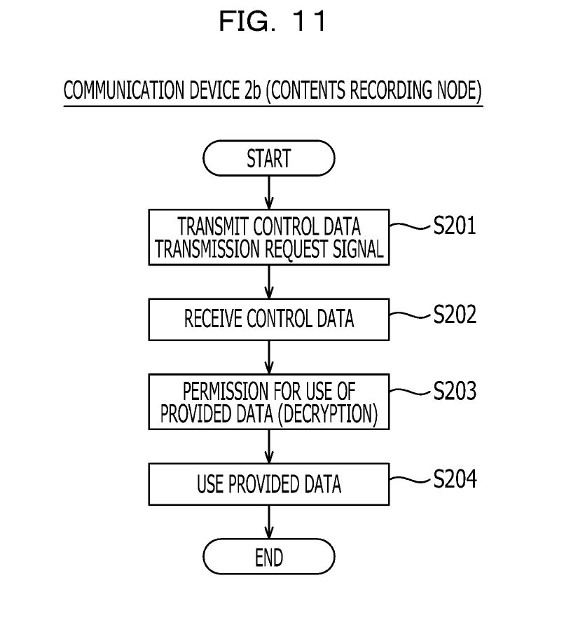

FIG. 11 is a flowchart illustrating an example of provided data use processing to be executed by the communication devices 2. The provided data use processing is processing until the communication device 2b serving as a contents recording node uses the obtained provided data.

The communication device 2b serving as a contents recording node transmits a control data transmission request signal for requesting transmission of the control data for permitting use of the recorded provided data to the information processing device 1 by the processing of the control data requesting unit 200b based on the control of the control unit 20 (S201). The control data transmission request signal is transmitted from the communication unit 24 via the communication network NW as a telegram message. The provided data identification information of the provided data according to the request is included in the telegram message to be transmitted. Note that in the event that a plurality of the provided data are recorded, transmission of the control data according to each of the provided data may be requested at a time.

The control unit 20 receives the control data replied from the information processing device 1 at the communication unit 24 as a response corresponding to the control data transmission request signal (S202).

The control unit 20 causes the provided data managing unit 201b to permit use of the provided data recorded in the provided data recording unit 221 using the received control data (S203). For example, in the event that the provided data is encrypted data, the provided data is decrypted by the control data, thereby permitting use of the provided data.

Subsequently, the control unit 20 causes the provided data managing unit 201b to use the provided data of which the use is permitted (S204). The use of the provided data of which the use is permitted is, for example, playback of video.

In this way, the provided data use processing is executed.

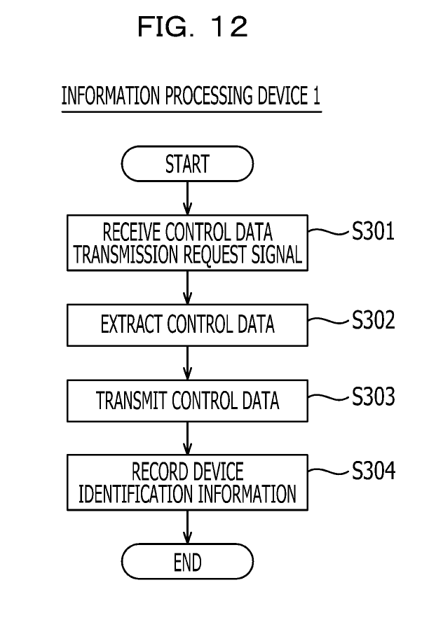

FIG. 12 is a flowchart illustrating an example of the control data transmission processing of the information processing device 1. The control data transmission processing is processing for transmitting the control data in response to the control data transmission request signal to be transmitted from the communication device 2b serving as a contents recording node, and is processing corresponding to the above provided data use processing.

The information processing device 1 executes the following processing as the control data transmission processing by the control of the control unit 10 for executing the control program PRG. The control unit 10 causes the control data request signal reception unit 100 to receive the control data transmission request signal from the communication device 2b at the communication unit 14 (S301).

The control unit 10 causes the control data transmission unit 101 to extract the control data from the control data recording unit 120 based on the request for transmission of the control data (S302). The processing in operation S302 is performed by referencing a record position recorded in the control data recording unit 120 based on the provided data identification information included in the telegram message according to the request to extract the control data recorded in the referenced record position. Note that in the event that a plurality of the provided data identification information is included in the telegram message, a plurality of the control data are extracted based on each piece of the provided data identification information.

The control unit 10 causes the control data transmission unit 101 to transmit the control data extracted from the control data recording unit 120 to the communication device 2b which is a requestor from the communication unit 14 via the communication network NW (S303).

Subsequently, the control unit 10 causes the control data transmission destination record processing unit 102 to record device identification information for identifying the communication device 2b which is a transmission destination to which the control data transmission unit 101 transmitted the control data in the control data transmission destination recording unit 122 as device identification information according to the transmission destination of the control data (S304). In operation S304, the device identification information, control data transmission period, and control data use period are recorded as a record correlated with the provided data identification information according to the transmitted control data.

In this way, the control data transmission processing is executed.

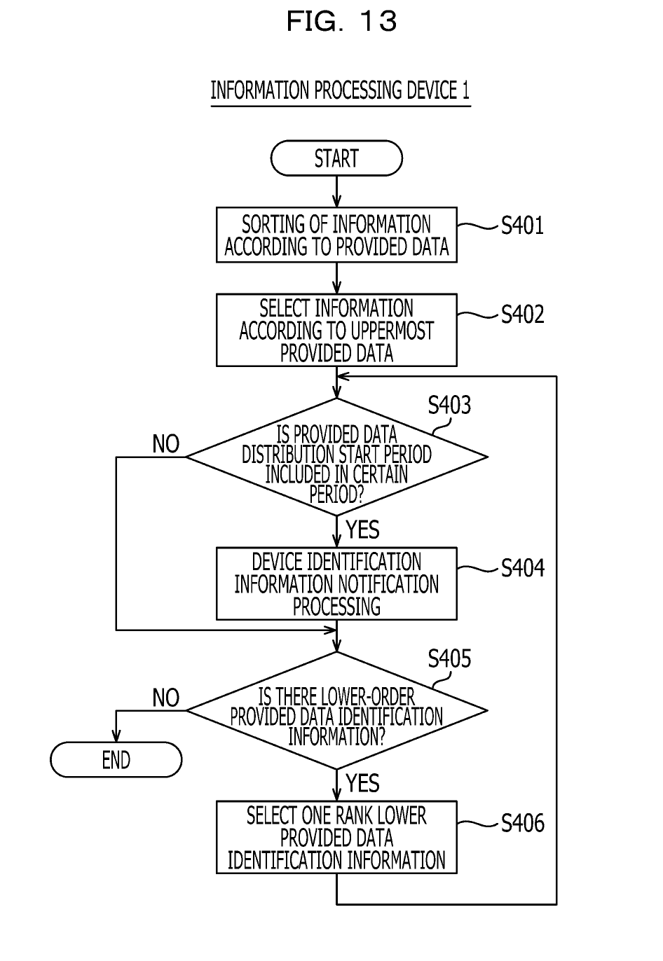

FIG. 13 is a flowchart illustrating an example of provided data identification information selecting processing of the information processing device 1. The provided data identification information selecting processing is processing to be executed as preprocessing of later-described device identification information notification processing, and is processing for selecting provided data identification information according to the provided data serving as a processing object in the device identification information notification processing.

The information processing device 1 executes the following processing in a certain cycle such as 10 minutes, 30 minutes, or the like as the provided data identification information selecting processing by the control of the control unit 10 for executing the control program PRG. The control unit 10 sorts information relating to the provided data recorded in the control data transmission destination recording unit 122 in accordance with order such as ascending order with the provided data identification information as a key (S401). The information relating to the provided data is information such as the provided data identification information, provided data distribution start period, provided data playback time, and so forth, recorded in the control data transmission destination recording unit 122.

The control unit 10 selects the uppermost sorted provided data identification information as a determination object (S402). In the event that the provided data identification information is sorted in ascending order as a key, the provided data identification information appended with the smallest number is selected.

The control unit 10 determines whether or not the provided data distribution start period corresponding to the selected provided data identification information is included in a certain period such as from two weeks ago up to now, or the like (S403). In the event that the present is included in a certain period from the provided data distribution start period, the control unit 10 determines that there are many users who desire to use the provided data, and takes the selected provided data identification information as an object for the device identification information notification processing. In the event that two weeks or more have elapsed since the provided data distribution start period, and the present is not included in a certain period, the control unit 10 determines that there are few users who desire to use the provided data, and excludes the selected provided data identification information from an object for the device identification information notification processing.

In the event that determination is made in operation S403 that the provided data distribution start period is included in a certain period (YES in S403), the control unit 10 selects the provided data identification information selected as a determination object as an object for the later-described device identification information notification processing, and executes the device identification information notification processing (S404).

In the event that determination is made in operation S403 that the provided data distribution start period is not included in a certain period (NO in S403), the control unit 10 does not executes the device identification information notification processing in operation S404 but executes processing in operation S405 and thereafter.

After executing or avoiding the device identification information notification processing, the control unit 10 determines whether or not there is provided data identification information of which the order is lower than the provided data identification information taken as the determination object (S405).

In the event that determination is made in operation S405 that there is provided data identification information of which the order is lower (YES in S405), the control unit 10 selects the provided data identification information of which the order is one rank lower than the provided data identification information taken as the determination object, as the next determination object (S406). Subsequently, the control unit 10 takes the selected provided data identification information as a processing object, returns to operation S403, and executes the subsequent processing.

In the event that determination is made in operation S405 that there is no provided data identification information of which the order is lower (NO in S405), the control unit 10 ends the provided data identification information selecting processing. Subsequently, after reaching a certain cycle, the control unit 10 repeats the processing from operation S401.

The desire for execution of the device identification information notification processing is determined regarding each provided data based on the provided data identification information by repeating the above processing, and the device identification information notification processing relating to the provided data identification information determined to be desired for execution is executed.

In this way, the provided data identification information selecting processing is executed.

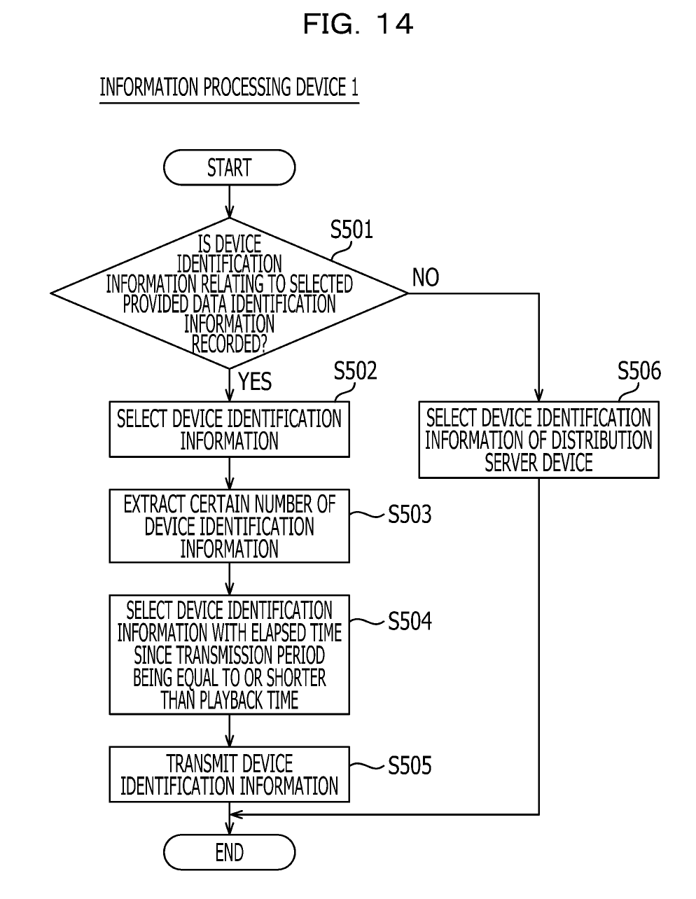

FIG. 14 is a flowchart illustrating an example of the device identification information notification processing of the information processing device 1. The device identification information notification processing is processing for selecting device identification information to be notified in response to a request, and notifying the communication device 2c which serves as a contents location managing node serving as a requestor of the device identification information described in the provided data obtaining processing, of the selected device identification information. Note that the device identification information notification processing is executed based on the provided data identification information selected as the processing object, as operation S404 of the provided data identification information selecting processing described with reference to FIG. 13.

The information processing device 1 executes the following processing as the device identification information notification processing by the control of the control unit 10 for executing the control program PRG. The control unit 10 causes the device selecting unit 103 to determine whether or not the device identification information correlated with the provided data identification information selected as the processing object is recorded in the control data transmission destination recording unit 122 (S501). The device identification information recorded in the control data transmission destination recording unit 122 is device identification information relating to the communication device 2b which has become a transmission destination of the control data in the control data transmission processing described with reference to FIG. 12. The communication device 2b which has become a transmission destination of the control data is assumed to be the communication device 2b having a high possibility that the provided data may be recorded. Therefore, in operation S501, the control unit 10 determines whether or not there is the device identification information correlated with the provided data identification information as whether or not there is the communication device 2b in which the provided data is recorded.

In the event that determination is made in operation S501 that the correlated device identification information is recorded in the control data transmission destination recording unit 122 (YES in S501), the control unit 10 causes the device selecting unit 103 to select the recorded device identification information (S502). In operation S502, the device selecting unit 103 selects the device identification information recorded in the control data transmission destination recording unit 122 as the device identification information of the communication device 2b in which the provided data is recorded. The selected device identification information is handled as device identification information to be notified from a contents location managing node in response to a request for device identification information according to the communication device 2b in which the provided data is recorded from a contents retrieval node in the provided data obtaining processing in FIG. 10. In the event that in operation S501 there are a plurality of the device identification information corresponding to the provided data identification information, all the device identification information is selected on this stage.

The control unit 10 causes the device selecting unit 103 to extract a certain number of device identification information such as 1000 or the like from the selected device identification information in order from the latest control data transmission period (S503). In operation S503, the later the control data transmission period is, i.e., the less time has elapsed since the control data was transmitted, the device selecting unit 103 regards this as a high possibility that the provided data may not be eliminated but recorded, and extracts a certain number of the device identification information from the control data transmission destination recording unit 122. Note that, as for the control data transmission period, data recorded in the control data transmission destination recording unit 122 in a manner correlated with the device identification information is employed. Alternatively, the device selecting unit 103 may extract the device identification information in order from the latest request signal reception period when receiving a request signal instead of the latest control data transmission period.

The control unit 10 selects device identification information of which the elapsed time from the control data transmission period is substantially equal to or shorter than the playback time of the provided data of the extracted device identification information (S504), by processing with the device selecting unit 103. The communication device 2b which has requested the control data plays the provided data of which the use is permitted by the control data, but in the event that playback time has not elapsed since transmission of the control data, playback of the provided data is assumed to be continued. Therefore, the device selecting unit 103 assumes the provided data of which the playback time has not elapsed since transmission of the control data to be low in possibility that the provided data may not be eliminated, and performs selecting processing for further narrowing down the extracted device identification information. Alternatively, the playback time has not elapsed since transmission of the control data, so there is a high possibility that this communication device 2b may be playing the provided data, and accordingly, there is a high possibility that this communication device 2b is in an activated state, so may be taken as a requestor candidate of the provided data. Note that the control data transmission period is recorded in the control data transmission destination recording unit 122 in a manner correlated with the device identification information, and the playback time is recorded in the control data transmission destination recording unit 122 as information relating to the provided data. Also, with regard to the use of the provided data, the provided data itself recorded in the communication device 2b is not used, and the provided data in a state wherein the use has been permitted by the control data is used, so the communication device 2b may transmit the provided data even during playback.

Narrowing down of the device identification information to be notified is performed by the processing in operations S503 and S504. A condition for narrowing down the device identification information may be other than the above example, or may be set as appropriate. For example, various conditions may be set such as selecting the device identification information within the provided data use period, and so forth. Subsequently, in the event that multiple conditions are set, rather than conditions being set so as to narrow down as with logical AND, conditions may be based on another logic operation such as logical OR or the like may be set.

Subsequently, the control unit 10 causes the device identification information transmission unit 104 to transmit the device identification information selected in operation S504 to the communication device 2c which serves as a contents location managing node from the communication unit 14 via the communication network NW (S505). The communication device 2c which is a transmission destination serves as a contents location managing node by recording the received device identification information, and the communication devices 2b according to the device identification information selected in operation S504 are regarded as contents recording nodes.

A condition for selecting the communication device 2c which serves as a contents location managing node may be set as appropriate as a transmission destination of the selected device identification information. For example, based on positions on logical space of the hash value of the device identification information, and the hash value of the provided data identification information, the communication device 2c according to device identification information having the same hash value as the hash value of the provided data identification information, or a hash value the most approximate thereto may be selected. Also, the communication device 2c may be selected using a random number. Further, an arrangement may be made wherein the device identification information selected in operation S504 is managed at the information processing device 1, and the information processing device 1 itself serves as a contents location managing node.

In the event that determination is made in operation S501 that no correlated device identification information is recorded (NO in S501), the control unit 10 selects device identification information for identifying a distribution server device (not illustrated) set beforehand as the device identification information (S506). Subsequently, the control unit 10 proceeds to operation S505, and executes the subsequent processing. Operation S506 is processing for using the device of a distributor of the provided data as a contents recording node.

In operation S505, after notifying the communication device 2c of the device identification information, the information processing device 1 may transmit information indicating that this communication device 2c is a contents location managing node to a broadcast via the communication network NW according to desire or need.

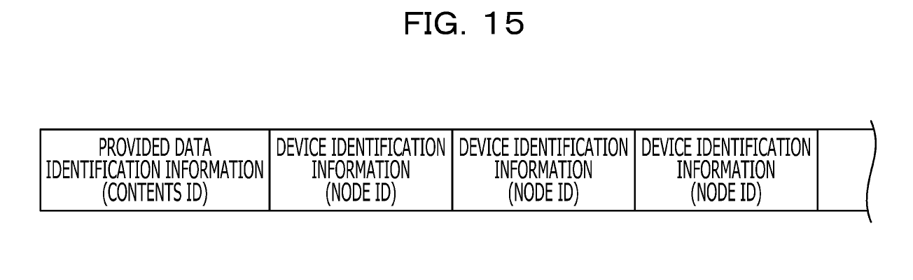

FIG. 15 is an explanatory diagram conceptually illustrating an example of the content of a telegram message that the information processing device 1 transmits. FIG. 15 illustrates device identification information to be transmitted from the information processing device 1 to the communication device 2c serving as a contents location managing node in operation S505 of the device identification information notification processing described with reference to FIG. 14. In operation S505, the device identification information is transmitted as an telegram message. As illustrated in FIG. 15, provided data identification information (content ID), and a single or plurality of device identification information (node ID) to be used as device identification information are included in the telegram message. The communication device 2c may obtain the device identification information of the communication devices 2b in which the provided data indicated with the provided data identification information is recorded as device identification information by receiving the telegram message illustrated in FIG. 15.

In this way, the device identification information notification processing is executed.

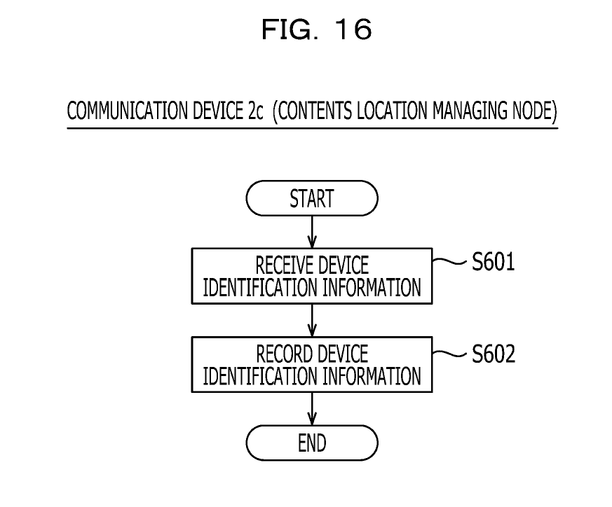

FIG. 16 is a flowchart illustrating an example of the device identification information recording processing of the communication device 2. The device identification information recording processing is processing for recording, at the communication device 2c which is a notification destination, the device identification information notified by the device identification information notification processing as device identification information.

The communication device 2c receives the device identification information at the communication unit 24 as the device identification information according to a transmission destination of the control data by the control of the control unit 20 (S601). The device identification information that is received in operation S601 is device identification information to be notified by the device identification information notification processing, and is received as the telegram message illustrated in FIG. 15.

The control unit 20 causes the control data transmission destination record processing unit 200c to record the received device identification information in the control data transmission destination recording unit 221c as device identification information according to the transmission destination of the control date in a manner correlated with the provided data identification information (S602). The communication device 2c serves as a contents location managing node by the processing in operation S602. After the device identification information is recorded as device identification information according to the transmission destination of the control data, the communication device 2c may transmit information indicating that it is a contents location managing node to broadcast via the communication network NW according to desire or need.

In this way, the device identification information notification processing is executed.

As described above, the information processing device 1 manages the communication device 2b serving as the transmission destination of the control data by regarding the communication device 2b as a contents recording node. Thus, excellent advantages are provided such as reduction in broadcast transmission of information notifying that the communication device 2b records the provided data, reduction in the processing load of the communication device 2b, and the communication load of the communication network NW, and so forth.

In particular, with a stage wherein distribution of new provided data is started, it may be conceived that transmission/reception of the provided data rapidly increases until the provided data goes around, so the communication load increases. Also, in the event that the communication device 2b which serves as a contents recording node records a plurality of the provided data, information for notifying that each piece of the provided data is recorded is repeatedly transmitted, so the processing load increases. Further, the more the number of the communication devices 2b increases, the more communication load increases. The more the current embodiment is applied to such a communication system such as a business for distributing new provided data one after another, a large-scale service with many users, or the like, the more marked the advantages thereof become.

Also, the communication device 2b regarded as a contents recording node is selected based on the playback time of the provided data, and the control data, so it may be conceived that there is a high possibility that this communication device 2b may be in a state in which the provided data is recorded, and also in an activated state.

### Other Embodiments

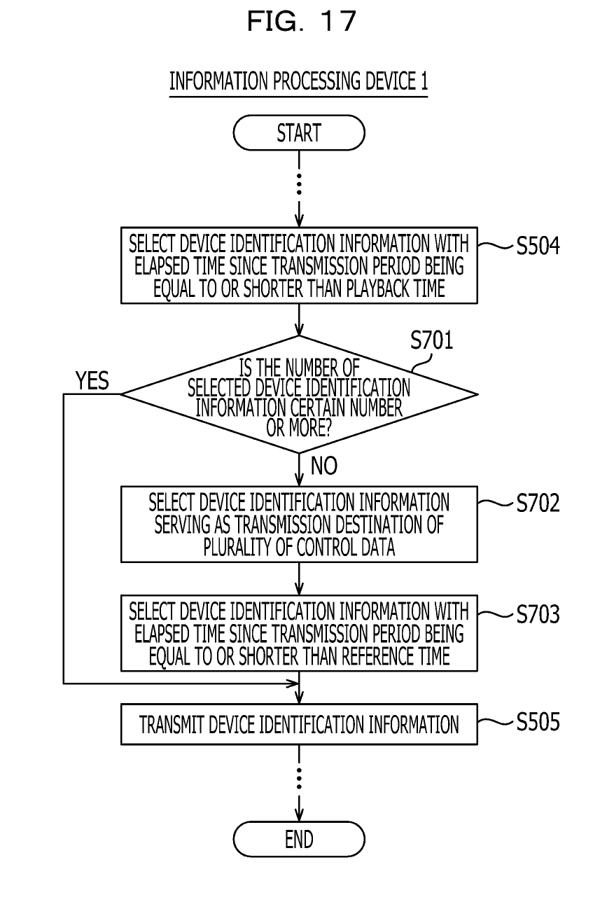

FIG. 17 is a flowchart illustrating an example of the device identification information notification processing of the information processing device 1. The information processing device 1 executes the following processing as the device identification information notification processing by the control of the control unit 10 for executing the control program PRG. Note that from the start of the processing to processing for selecting device identification information based on elapsed time from the transmission period of the control data is substantially the same as the processing in operations S501 through S504 of the device identification information notification processing described with reference to FIG. 14, and description thereof will be omitted.

After selecting the device identification information matched with the conditions in operations S501 through S504, the control unit 10 determines according to the processing of the device selecting unit 103 whether or not the number of the selected device identification information is equal to or greater than a certain number such as 100 or the like (S701). In the event of a certain number or more, determination is made that the number of the communication devices 2b to be notified as contents recording nodes is sufficient, but in the event of less than a certain number, determination is made that the number of the communication devices 2b is insufficient. In the event that the number of the communication devices 2b is insufficient, concentration of a request for the provided data as to a small number of the communication devices 2b may be conceived, so processing for securing a certain number or more of contents recording nodes is executed by the following processing.

In the event that determination is made in operation S701 that the number of the selected device identification information is equal to or greater than a certain number (YES in S701), the control unit 10 executes the processing in operation S505 and thereafter of the device identification information notification processing described with reference to FIG. 14.

In the event that determination is made in operation S701 that the number of the selected device identification information is less than a certain number (NO in S701), the control unit 10 selects device identification information according to the communication device 2b serving as the transmission destination of a plurality of the control data by the processing of the device selecting unit 103 (S702). Operation S702 is processing for selecting, of the device identification information extracted in operation S503, the device identification information according to the communication device 2b serving as the transmission destination of the plurality of the control data including the control data according to the provided data identification information that is a processing object.

The control unit 10 selects, out of the device identification information selected in operation S702, device identification information wherein elapsed time since the transmission period of the control data is substantially equal to or shorter than reference time based on the playback time of the provided data (S703), with processing of the device selecting unit 103. In operation S703, device identification information is selected wherein elapsed time since the transmission period of the control data is substantially equal to or shorter than reference time that is a total value of the playback time according to the plurality of the provided data. This is processing for selecting the communication device 2b considered to have a high possibility that playback of all the provided data may not be completed, and accordingly may be activated. Note that, in this case, in operation S702, device identification information according to the communication device 2b serving as the transmission destination of a plurality of the control data with the transmission period being substantially the same period or less than a certain period is selected. Also, the transmission period of the control data is preferably the transmission period of the control data that has been transmitted first of the transmission periods of the plurality of the control data. Further, device identification information according to the communication device 2b with the number of the transmitted control data being great may preferentially be selected.

Note that, as the processing in operation S703, the elapsed time since the transmission period of the control data last transmitted of the plurality of the control data may be compared to the reference time based on the playback time of the provided data according to this control data. Further, in the event that the number of the device identification information to be additionally selected in operation S703 is great, the upper limit may be provided.

Subsequently, the control unit 10 executes, in order to transmit the selected device identification information, the processing in operation S505 and thereafter of the device identification information notification processing described with reference to FIG. 14.

In this way, the device identification information notification processing is executed.

As described above, in the event that the number of the available communication devices 2b serving as a requestor candidate of the provided data is insufficient, a suitable communication device 2b is additionally selected in light of the transmission situations of the plurality of the control data.

### Other Embodiments

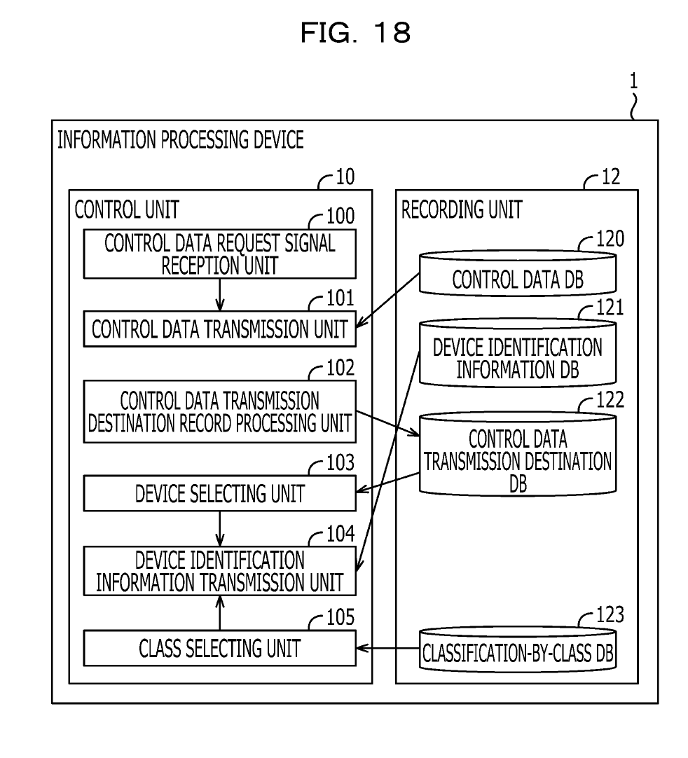

FIG. 18 is a functional block diagram illustrating the functions of the information processing device 1 according to one embodiment. The information processing device 1 executes the control program PRG based on the control of the control unit 10, thereby executing the functions of the control data request signal reception unit 100, control data transmission unit 101, control data transmission destination record processing unit 102, device selecting unit 103, device identification information transmission unit 104, class selecting unit 105, and so forth. Note that a circuit for realizing the functions of the control data transmission unit 101, control data transmission destination record processing unit 102, device selecting unit 103, device identification information transmission unit 104, class selecting unit 105, and so forth may be embedded in the control unit 10 instead of execution of the control program PRG.

The class selecting unit 105 is an element such as a program module, circuit, or the like for causing the control unit 10 to operate so as to select, based on the classification results performed by a certain method as to each piece of the device identification information, a class to which the communication device 2 to be a communication path candidate for transmitting the device identification information belongs. The certain method is a method for classifying, based on the position on the N-dimensional logical space indicated with N-digit binary (N is a natural number) yielded from the device identification information, each piece of the device identification information with distance from itself on the logical space as a reference. The N-digit binary value is a hash value to be recorded in the device identification information recording unit 121, and is yielded by subjecting the device identification information to irreversible transformation using a certain hash function.

Also, the information processing device 1 executes the control program PRG based on the control of the control unit 10, thereby using a portion of the record region of the recording unit 12 as various types of databases. The various types of databases are, for example, databases such as the control data recording unit 120, device identification information recording unit 121, control data transmission destination recording unit 122, classification-by-class recording unit (classification-by-class DB) 123, and so forth. Note that besides a portion of the record region of the recording unit 12 being used as various types of databases, another recording device connected to the information processing device 1 may be used as various types of databases.

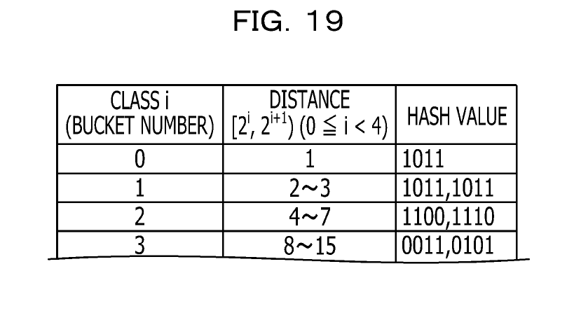

FIG. 19 is an explanatory diagram conceptually illustrating an example of the record content of the classification-by-class recording unit 123 of the information processing device 1 according to one embodiment. The classification-by-class recording unit 123 is a routing table to be used for determination of a transmission route at the time of transmitting device identification information to the communication device 2c which serves as a contents location managing node. Various types of information such as classes for classifying each of the communication devices 2 based on distance on logical space, a range of distance stipulated based on classes, device identification information, a hash value yielded from the device identification information, and so forth are recorded in the classification-by-class recording unit 123 in a manner correlated with each other in increments of records. Note that information according to each communication device 2 indicated with a hash value is correlated with information such as the device identification information, position information, and so forth recorded in the device identification information recording unit 121.

At the time of selecting a route, N-dimensional logical space indicated with an N-digit binary value is assumed. Subsequently, a hash value indicated with an N-digit binary value yielded by subjecting the device identification information to irreversible transformation using a hash function is used as position information indicating a position on the logical space. Note that, in the event that the device identification information is indicated with an N-digit binary value, the device identification information may be used as position information indicating a position on the logical space. The distance from the information processing device 1 to each of the communication devices 2 is calculated as exclusive logical OR of each piece of the device identification information or a hash value by assuming the N-dimensional logical space indicated in binary.

A class (bucket number) based on distance on the logical space is indicted as “i” that takes 0 or the value of a natural number. Specifically, the class is i=0, 1, 2, 3, and so on. The range of distance stipulated based on classes is a range stipulated as [2ⁱ, 2ⁱ⁺¹) (0≦i≦the number of digits of a hash value). Accordingly, in the event that the class is “0”, the range of distance is “1”, and in the event that the class is “1”, the range of distance is “2 through 3”, and in the event that the class is “2”, the range of distance is “4 through 7”. As illustrated in the classification-by-class recording unit 123, each of the communication devices 2 is classified based on distance on the logical space from the information processing device 1. Note that, with this embodiment, in order to facilitate understanding, an example employing a 4-digit hash value will be described, but at the time of implementation, a hash value of a number of digits such as 160 digits or the like is employed according to a system scale.

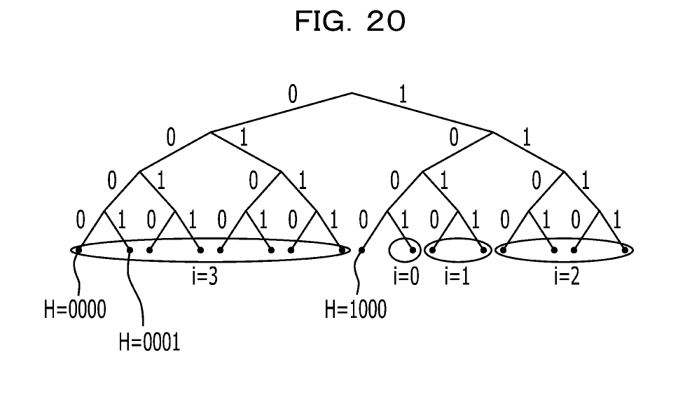

Description will be made regarding a method for determining a transmission route employing classes. FIG. 20 is an explanatory diagram conceptually illustrating an example of relationship between a class and a communication route with the communication system. In FIG. 20, each node used as the information processing device 1 or communication device 2 is disposed as a tree diagram based on hash values. Filled circles on the end of the tree map each indicate nodes. A numeric value of “0” or “1” illustrated in a branch position indicates the value of each digit of a hash value from the most significant digit to the least significant digit. For example, the hash value H of a node on the left edge in FIG. 20 is “0000”, and the hash value H of a right-hand node thereof is “0001”. In FIG. 20, the hash value H of the information processing device 1 is assumed to be “1000”. In this case, relationship between the hash value H and the class i is illustrated as a block for each branch as illustrated in FIG. 20.

Description will be made regarding an example wherein the information processing device 1 of which the hash value is “1000” transmits device identification information according to the provided data of which the provided data identification information is “C0” to the communication device 2c which serves as a contents location managing node. The information processing device 1 calculates the hash value H of the provided data identification information “C0” (C0)=“0000”, and selects the communication device 2c of which the hash value of the device identification information is “0000”, as a contents location managing node. Subsequently, in the event of transmitting the device identification information to the communication device 2c which is “0000”, the information processing device 1 selects the communication device 2 corresponding to “0011”, of which the distance on the logical space is close to “0000” from hash values recorded in the classification-by-class recording unit 123, as the transmission destination. The hash value “0011” close to “0000” is the communication device 2 having the same class as with “0000”. With the example of the classification-by-class recording unit 123 illustrated in FIG. 19, the communication device 2 belonging to the class of i=3 becomes the communication device 2 having the same class as with “0000”. Note that the class is yielded by calculating distance with the hash value “1000” of the information processing device 1.

Subsequently, the information processing device 1 transmits the device identification information to the selected communication device 2. In the event of having recorded the position of the communication device 2c serving as the final transmission destination, the communication device 2 which has received the device identification information transmits the device identification information to the communication device 2c thereof. In the event of having recorded no position, the communication device 2 transmits the device identification information to the communication device 2 of the hash value with the class based on the distance from itself belonging to the same class as with the communication device 2c which serves as a contents location managing node. According to repetition of such communication, the device identification information is transferred from the information processing device 1 to the communication device 2c. Also, the communication device 2 which has relayed transfer of the device identification information recognizes which communication device 2 the communication device 2c which serves as a contents location managing node is. As for selection of such a route, the DHT (Distributed Hash Table) algorithm technology such as Chord, Pastry, Kademlia, or the like is employed as appropriate.

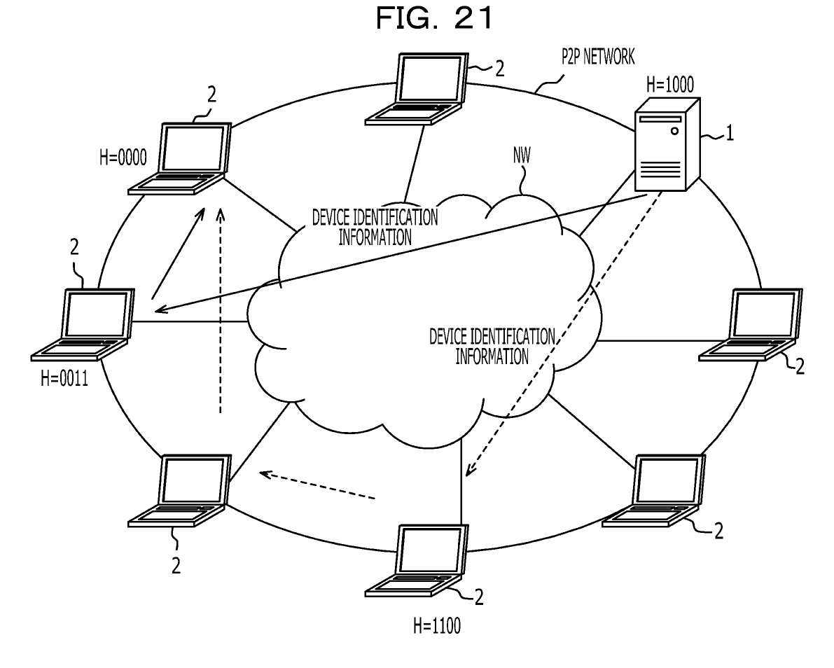

FIG. 21 is an explanatory diagram conceptually illustrating an example of a transmission route of the device identification information with the communication system. FIG. 21 illustrates an example of a transmission route in the event that the device identification information is transmitted to the communication device 2c which serves as a contents location managing node from the information processing device 1. As described above, in the event of transmitting the device identification information to the communication device 2c, the information processing device 1 does not necessarily directly transmit the device identification information to the communication device 2c. The above example illustrates an example wherein the device identification information is transferred from the information processing device 1 to the communication device 2c using the route indicated with a solid line in FIG. 21. Also, at the time of transferring the device identification information, the communication device 2 which has performed relay recognizes which communication device 2 the communication device 2c which serves as a contents location managing node is.

Subsequently, the information processing device 1 does not fix a communication route to be selected, but changes a communication route to be selected with a certain regularity. For example, restrictions are provided so as not to consecutively select the communication device 2 belonging to the same class a certain number of times or more to select a different communication route. With the examples illustrated in FIGS. 19 and 20, the class of the hash value “0011” is “3”, so for example, the communication device 2 of i=2 is selected so as not to continue the communication device 2 of i=3 a certain number of times or more. The communication route indicated with a dashed line in FIG. 21 illustrates a communication route in the event that the communication device 2 of a hash value “1100” of which the class is “2” has been selected as the first transmission destination of the device identification information.

Preventing the communication route from being fixed leads to the communication device 2 which recognized the position of the communication device 2c which serves as a contents location managing node being distributed. Alternatively, the device identification information may be recorded in the communication device 2 which has become the route of the device identification information so as to be served as a contents location managing node, and in this case, multiple communication devices 2c which serve as a contents location managing node are distributed.

Next, the processing of various types of devices according to another embodiment will be described. Note that the provided data obtaining processing, provided data use processing, control data transmission processing, provided data identification information selecting processing, and device identification information recording processing of the communication system according to this embodiment are substantially the same as with already-described embodiment, description thereof will be omitted with reference to the already-described embodiment.

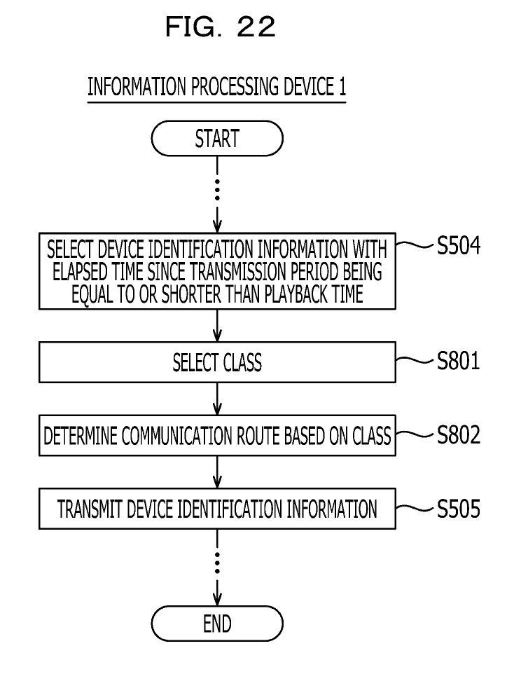

FIG. 22 is a flowchart illustrating an example of the device identification information notification processing of the information processing device 1 according to the one embodiment. The information processing device 1 executes the following processing as record notification processing by the control of the control unit 10 for executing the control program PRG. Note that from the start of the processing to processing for selecting device identification information based on elapsed time from the transmission period of the control data is substantially the same as the processing in operations S501 through S504 of the device identification information notification processing described with reference to FIG. 14, so description thereof will be omitted.

After selecting the device identification information matched with the conditions in operations S501 through S504, the control unit 10 selects one class out of multiple classes with distance recorded in the classification-by-class recording unit as a reference according to the processing of the class selecting unit 105 (S801). Classes to be selected are restricted so that the same class is not consecutively selected a certain number of times or more. For example, like an example described with reference to FIGS. 20 and 21, in the event that a class of i=2 has been selected consecutively three times, a class other than “2” is selected.

The control unit 10 determines a communication route based on the class so that the communication device 2 belonging to the selected class becomes the first transmission destination (S802).

Subsequently, the control unit 10 executes the processing in operation S505 and thereafter of the device identification information notification processing described with reference to FIG. 14 so as to transmit the device identification information by the determined communication route.

In this way, the device identification information notification processing is executed.

As described above, the communication device 2 which recognizes the position of the communication device 2c which serves as a contents location managing node, and the communication device 2c which serves as a contents location managing node are distributed. Thus, load is prevented from being concentrated on a part of the devices and routes.

The above embodiments exemplify only a part of countless embodiments. The layout of various types of devices may be designed or changed according to purpose, use, or the like. Methods for realizing the function of each of the devices by hardware or software may be designed or changed according to purpose, application, or the like. Alternatively, the above embodiments may be combined according to purpose or application as appropriate, rather than being independently implemented.

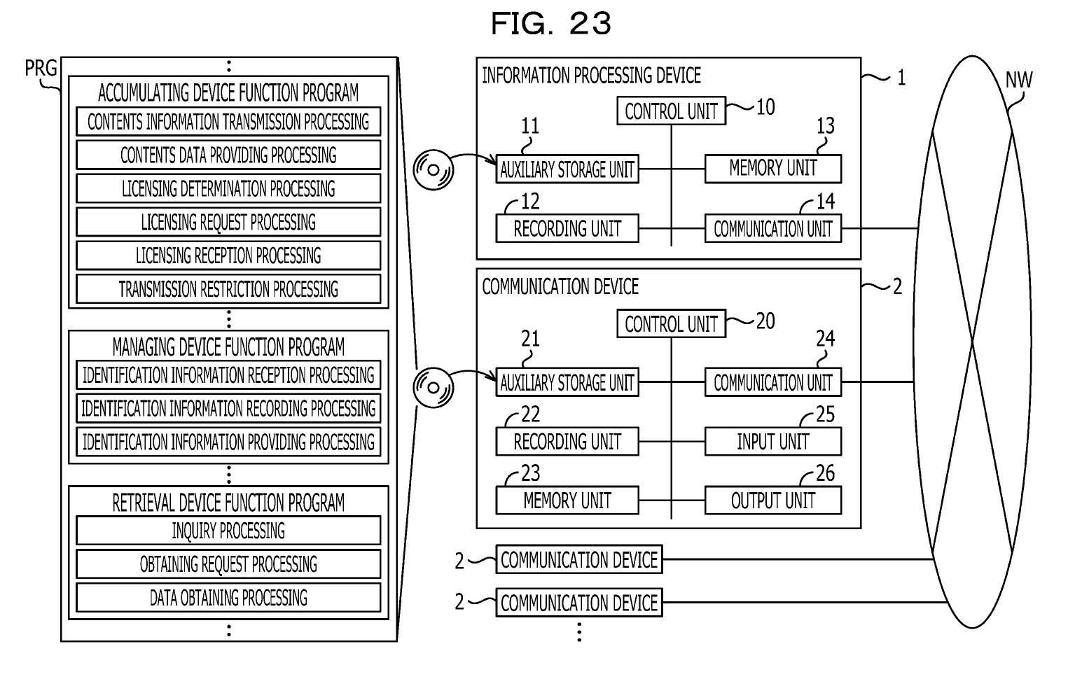

FIG. 23 is a block diagram illustrating the communication device according to one embodiment. With the communication device for realizing a P2P network, the P2P program (PRG) described in FIG. 23 is installed into the auxiliary storage unit 21. The installed P2P program includes an accumulating device function program, a managing device function program, and a retrieval device function program. The accumulating device function program serves as a contents recording node, accumulates provided contents data, and provides contents data in response to a request. The retrieval device function program serves as a contents retrieval node, and retrieves a device for providing contents to download contents data. The managing device function program serves as a contents location managing node, receives contents information for identifying contents data from an accumulating device, records the contents information along with device identification information for identifying an accumulating device, and in response to inquiry of contents information, replies the device identification information corresponding to the contents information.

The accumulating device function program includes contents information transmission processing, contents data providing processing, licensing determination processing, licensing request processing, licensing reception processing, and transmission restriction processing. The contents information transmission processing generates contents information for determining the accumulated contents data, and periodically transmits contents information to a managing device. The contents data providing processing provides contents data according to an obtaining request to a requestor. The licensing determination processing determines, in the event that an instruction for executing the accumulated contents data has been issued, whether or not licensing information is required. The licensing request processing determines, in the event that determination is made in the licensing determination processing that licensed information is required, an information processing device which manages licensed information, and transmits an obtaining request for licensed information to the determined information processing device. The licensing reception processing receives licensed information transmitted from the information processing device. The transmission restriction processing restricts so that the contents information corresponding to the received licensed information is not subjected to transmission processing. According to this processing, load of a network, and load of a managing device are reduced. Note that the licensed information to be transmitted from the information processing device is not restricted to information for permitting use, and may be information for limiting use.

The managing device function program includes identification information reception processing, identification information recording processing, and identification information providing processing. The identification information reception processing receives information including the contents information transmitted from the accumulating device, information processing device, or another managing device, and device identification information. The identification information recording processing records the received contents information and device identification information as a set. The identification information providing processing retrieves, based on a retrieval request including contents information, the recorded contents information, and transmits the device identification information corresponding to the contents information.

The retrieval device function program includes inquiry processing, obtaining request processing, and data obtaining processing. The inquiry processing transmits a retrieval request including contents information to a managing device, and receives the device identification information of an accumulating device for accumulating contents data. The obtaining request processing transmits an obtaining request for contents data including contents information to the accumulating device. The data obtaining processing receives the contents data provided by the accumulating device.

These programs are recorded in a computer-readable storage medium, and are distributed. Here, examples of the computer-readable storage medium include nonvolatile storage media, for example, such as flexible disks, hard disks, CD-ROM (Compact Disc-Read Only Memory), MO (Magneto Optical disk), DVD, DVD-ROM, DVD-RAM (DVD-Random Access Memory), BD (Blu-ray Disc), USB memory, semiconductor memory, and so forth. The computer program may be a program to be transmitted via an electric telecommunication line, wireless or cable telecommunication line, a network of which the Internet is representative, or the like. However, the computer-readable storage medium includes no carrier wave in which the computer program is embedded. Even with a computer program to be transmitted by being embedded in carrier waves, there is a readable storage medium mounted on a computer which is a transmission source of the program thereof. Accordingly, the computer-readable storage medium is a storage medium having a physical entity.

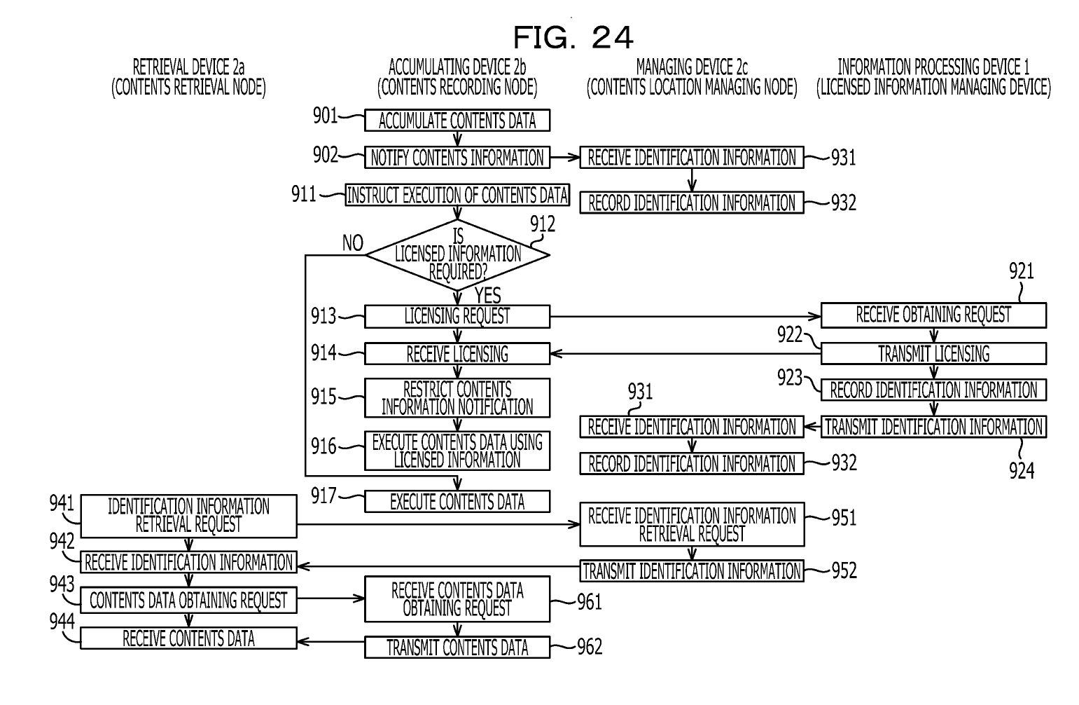

FIG. 24 is a flowchart illustrating the operation of a program of a communication device.

A user who uses a communication device which serves as an accumulating device specifies contents data to be provided. Upon the user specifying the contents data, processing in operation 901 records the specified contents data in a database. Processing in operation 902 reads out a contents name that is contents information for determining the recorded contents data, and calculates a hash value from the contents name. The processing in operation 902 finds out device identification information most approximated to the calculated hash value. The device identification information found out at this time becomes a managing device which manages the location of this contents data. The processing in operation 902 periodically transmits the contents information, and the device identification information of itself to the found managing device.

Upon the contents information and device identification information being transmitted from the accumulating device, the managing device receives these in operation 931. In operation 931, the managing device registers the received contents information and device identification information on the database in a correlated manner. At the time of receiving the contents information, the managing device calculates a hash value from the received contents information, confirms whether or not it is itself the most suitable as a managing device, and in the event of finding out another managing device more suitable than itself, transmits the contents information and device identification information to the found other managing device. With such transfer processing, information registered on the database is similarly processed as well as the received information. Accordingly, out of the information registered on the database, in the event that a communication device which has newly participated is more suitable than itself as a managing device, processing for reading out the information thereof from the database to transfer this to the managing device is performed.

Upon the user giving an instruction for executing contents data accumulated in the accumulating device, operation 911 detects the user's execution instruction to activate a contents execution process. Operation 912 determines whether or not the contents data to be executed is data that requires licensed information, and in the event that licensed information is required, branches to operation 913, and in the event that no licensed information is required, branches to operation 917. Operation 913 after determining that licensed information is required, and branching transmits a licensed information obtaining request including contents information for determining contents data desired or necessary for licensed information, and the device identification information of itself to an information processing device which manages licensed information. Operation 914 receives the licensed information transmitted from the information processing device. In operation 915, processing is performed so as to substantially prevent the contents information corresponding to the received licensed information from being transmitted out of information to be periodically transmitted in operation 902, for example, by setting a flag to the contents data with licensed information being received. Operation 916 executes the contents data using the received licensed information. Also, operation 917, which has been branched to after determining in operation 912 that that no licensed information is required, executes the contents data without using licensed information.

Upon the licensed information obtaining request being transmitted from the accumulating device in operation 913, in operation 921 the information processing device receives the licensed information obtaining request, and retrieves licensed information based on the contents information included in the received licensed information obtaining request. Operation 922 transmits the retrieved licensed information to the accumulating device. Operation 923 records the contents information and device identification information included in the licensed information obtaining request. Operation 924 extracts device identification information to be transmitted based on the recorded device identification information, and transmits the contents information, and the device identification information corresponding to the contents information to the managing device. Note that a method for determining a managing device is substantially the same as with operation 902.

The retrieval device performs processing in operation 941 based on the contents information instructed by the user. Operation 941 determines a managing device, in substantially the same way as operation 902, based on the contents information instructed by the user, and transmits a device identification information retrieval request including the contents information to the managing device. Upon receiving the device identification information retrieval request, in operation 951 the managing device uses the contents information to retrieve the database, and extracts device identification information to which the contents data corresponding to the contents information is provided. Operation 952 transmits the extracted device identification information to the requesting retrieval device. In operation 942, the retrieval device receives the device identification information transmitted from the managing device. Operation 943 uses the received device identification information to transmit a contents data obtaining request including the contents information to the accumulating device. The accumulating device retrieves contents data from the received contents information in operation 961. Operation 962 transmits the retrieved contents data to the retrieval device. In operation 944, the retrieval device receives the transmitted contents data.

Note that the drawing of a mobile PC is represented as a communication device in the drawing, but the communication device is not restricted to mobile PCs, any type of computer may be employed as long as an application program for realizing a P2P network may execute this computer, and for example, a device having a function for communicating using a network, and a function for executing a program may be employed such as a desktop PC, smart phone, cellular phone, or the like.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. An information processing device comprising:
a control data request signal reception unit configured to receive a request signal for requesting transmission of control data used for processing for controlling whether or not provided data to be provided to a communication device is available in the communication device;
a control data transmission unit configured to transmit control data required by the received request signal to a communication device which is a requestor that sends the request signal;
a control data transmission destination recording unit configured to record device identification information used for identification of a communication device which is a transmission destination of the control data in a manner correlated with identification information for identifying this provided data;
a device selecting unit configured to select device identification information recorded in the control data transmission destination recording unit in a manner correlated with identification information for identifying the provided data; and
a device identification information transmission unit configured to transmit the selected device identification information to a communication device on a P2P network as device identification information used for identification of a communication device in which the provided data is recorded.

2. The information processing device according to claim 1, wherein the control data transmission destination recording unit records information indicating time when receiving the request signal or transmitting the control data in a manner correlated with identification information for identifying the provided data, and the device identification information;
and wherein the device selecting unit selects, of device identification information recorded in the control data transmission destination recording unit, device identification information in later the time.

3. The information processing device according to claim 1, wherein the provided data is playback data for playing audio or video;
and wherein the device selecting unit is configured to select device identification information so that time elapsed since the information indicating time is included in a threshold determined based on playback time indicating time length allotted for playback of the provided data.

4. The information processing device according to claim 1, wherein the device selecting unit is configured to select device identification information to be used for identification of a communication device which has become a transmission destination of a plurality of control data as device identification information to be informed.

5. The information processing device according to claim 1, further comprising:
a device identification information recording unit configured to record a plurality of device identification information according to a communication device;
a classification-by-class recording unit configured to classify, based on a position on N-dimensional logical space indicated with N-digit (N is a natural number) binary based on device identification information recorded in the device identification information recording unit, each piece of device identification information into classes to be recorded with distance from the corresponding device on the logical space as a reference; and
a class selecting unit configured to select one class from a plurality of classes with distance recorded in the classification-by-class recording unit as a reference;
wherein the device identification information transmission unit is configured to transmit device identification information using a communication route passed through a communication device according to a device identification information included in the class selected by the class selecting unit.

6. The information processing device according to claim 5, wherein limitations are provided to the class selecting unit regarding the number of times for consecutively selecting the same class.

7. A communication system comprising:
an information processing device; and
a first communication device configured to request transmission of control data to be used for processing for controlling whether provided data that has been provided is available in the first communication device from the information processing device;
wherein the first communication device includes,
a provided data recording unit configured to record provided data that has been provided, and
a provided data transmission unit configured to transmit the provided data recorded in the provided data recording unit in response to a request for provided data from another device.

8. The communication system according to claim 7, further comprising:
a second communication device different from the first communication device to record device identification information indicating a transmission destination of control data transmitted from the information processing device;
wherein the second communication device includes,
a transmission unit configured to transmit device identification information recorded as a transmission destination of control data in response to a request for device identification information for identifying a communication device in which provided data is recorded.

9. A control method comprising:
prompting an information processing device, which is connected to a communication network to which a plurality of communication devices are connected, to receive a request signal for requesting transmission of control data to be used for processing for controlling whether provided data to be provided to a communication device is available in the communication device;
prompting the information processing device to transmit control data requested by the received request signal to a communication device which is a requestor that sends the request signal;
prompting the information processing device to record device identification information to be used for identification of the requestor communication device which is a transmission destination of the control data in a manner correlated with the provided data;
prompting the information processing device to select device identification information recorded in the control data transmission destination recording unit in a manner correlated with identification information for identifying the provided data; and
prompting the information processing device to transmit the selected device identification information to a device on a P2P network as device identification information to be used for identification of a communication device in which the provided data is recorded.

10. A recording medium in which a control program is recorded, the control program causing a computer to execute processing comprising:
receiving a request signal for requesting transmission of control data used for processing for controlling whether provided data provided to a communication device is available in the communication device;
transmitting control data required by the received request signal to a communication device which is a requestor that sends the request signal;
recording, in a control data transmission destination recording unit, device identification information used for identification of a communication device which is a transmission destination of the control data in a manner correlated with this provided data;
selecting the device identification information recorded in the control data transmission destination recording unit in a manner correlated with identification information for identifying the provided data; and
transmitting the selected device identification information to a device on a P2P network as device identification information used for identification of a communication device in which this provided data is recorded.

11. An information processing device comprising:
a communication unit configured to communicate with a communication device;
a licensed information recording unit configured to record licensed information corresponding to contents data;
a request reception unit configured to receive a request signal for requesting the licensed information, which includes contents information for determining the contents data, and device identification information for identifying the communication device;
a licensed information transmission unit configured to read out requested licensed information from the licensed information recording unit to transmit to a communication device corresponding to the device identification information;
a transmission destination recording unit configured to record the device identification information in a manner correlated with the contents information; and
an identification information transmission unit configured to transmit device identification information recorded in the transmission destination recording unit to a communication device which manages the device identification information of the communication device.

12. A recording medium in which a program is recorded, the program causing a computer to execute processing comprising:
accumulating contents data;
transmitting the device identification information of the own device, and contents information for determining the contents data to a managing device configured to manage the locations of contents;
providing the contents data according to an obtaining request for the contents data;
determining whether licensed information for controlling whether or not the contents data is available is necessary;
transmitting, in the event of determining that the licensed information is necessary, an obtaining request for the licensed information to an information processing device which manages the licensed information along with contents information and the device identification information;
receiving the licensed information from the information processing device; and
restricting transmission of contents information corresponding to the received licensed information, during processing for transmitting to the managing device.

13. The recording medium according to claim 12, with the program recorded therein causing the computer to execute processing further comprising:
receiving the contents information and device identification information;
storing the device identification information in a manner correlated with the contents information; and
transmitting the device identification information to a retrieval device which is an inquiry source in response to inquiry information including the contents information.

14. The recording medium according to claim 12, with the program recorded therein causing the computer to execute processing further comprising:
transmitting inquiry information including contents information to the managing device;
issuing an obtaining request to an accumulating device for providing contents data based on device identification information transmitted from the managing device; and
obtaining contents data from the accumulating device.
